(19) United States
(12) Patent Application Publication
(10) Pub. No.: US 2016/0337618 A1
(43) Pub. Date: Nov. 17, 2016

(54) INTELLIGENT VIDEO, AUDIO, DATA AND COMMUNICATION EMBODIMENT FOR CANINES OR OTHER ANIMALS

(71) Applicants: Howard M. Chapman, Chantilly, VA (US); David A. Bentley, Manassas, VA (US)

(72) Inventors: Howard M. Chapman, Chantilly, VA (US); David A. Bentley, Manassas, VA (US)

(21) Appl. No.: 15/153,355

(22) Filed: May 12, 2016

Related U.S. Application Data
(60) Provisional application No. 62/179,569, filed on May 12, 2015.

(51) Int. Cl. H04N 7/18; H04B 7/155; H04N 5/232; F41H 11/00; H04R 1/02; H04N 5/33; G01S 19/13; F41H 9/04; H04B 1/3827; H04N 5/225

(52) U.S. Cl. CPC H04N 7/181; H04B 1/385; H04B 7/15507; H04N 5/23206; H04N 5/2252; H04R 1/028; H04N 5/33; H04N 5/2256; G01S 19/13; F41H 9/04; F41H 11/00; H04W 80/04

(57) ABSTRACT

A saddle apparatus including a processor, a plurality of sensors controlled by the processor, a plurality of output peripherals controlled by the processor, a deployment unit controlled by the processor, a transceiver controlled by the processor and communicating with a remote control device, a computer readable storage medium storing program instructions, and the processor executing the program instructions, the processor configured to receiving control signals from the remote control device, instructing the plurality of sensors, the plurality of output peripherals and deployment unit according to the received control signals, and sending a return signal with data processed by the processor from the plurality of sensors, the plurality of output peripherals and the deployment unit to the remote control device external from the saddle apparatus.

### CROSS REFERENCE TO RELATED APPLICATIONS

The present application is based on and claims priority from provisional U.S. Patent Application No. 62/179,569, filed on May 12, 2015, the entire contents of which are incorporated herein by reference.

### BACKGROUND OF THE INVENTION

1. Field of the Invention

The disclosed invention relates generally to an apparatus, method and system for real time remote mobile intelligence, surveillance, and reconnaissance, and more particularly, but not by way of limitation, relating to a system, apparatus, and method for a mobile real time situational awareness platform by integrating video, bidirectional audio, data, microprocessor(s), sensors, illuminators, electro-mechanical components and communication devices into a saddle embodiment that collects information and conveys information data via wireless radios to one or more handheld or stationary computing device(s). The disclosed invention is a mobile ISR (intelligence, surveillance, and reconnaissance) platform that includes an intelligent video, audio, data and communication embodiment for canines or other animals.

2. Description of the Related Art

Recently there has been a great demand to add remote situation awareness to animals and humans. However, adding video, audio, data, and communication capabilities to animals, such as a working dog, has been difficult in several disciplines.

There has been a problem with integrating devices to animals since such devices may affect the animals to where the animal cannot function. The devices have been bulky, or inhibit the movement of the animals or create distractions. Communication with such devices has also been a problem. If increased hardware is added to promote communication, such bulk may add weight that makes movement difficult for the working dog. The reliability of such devices has also been a problem where they do not function in the field where there are a plurality of difficult environmental conditions that may adversely affect the device and/or communication with the device. The current devices also have difficulty in providing for real time intelligence, surveillance, and reconnaissance, or real time situational awareness because of the deficiencies in the integration and communication and positioning of video devices and the resulting video shake.

Therefore, there is a need for providing a mobile device that can provide remotely real-time situational awareness, that is reliable and functional on an animal or human.

### SUMMARY OF INVENTION

In view of the foregoing and other problems, disadvantages, and drawbacks of the aforementioned background art, an exemplary aspect of the disclosed invention provides a system, apparatus, and method of providing for mobile ISR (intelligence, surveillance, and reconnaissance) platform that includes an intelligent video, audio, data and communication embodiment for canines or other animals and humans.

One example aspect of the disclosed invention provides a saddle apparatus including a processor, a plurality of sensors controlled by the processor, a plurality of output peripherals controlled by the processor, a deployment unit controlled by the processor, a transceiver controlled by the processor and communicating with a remote control device, a computer readable storage medium storing program instructions, and the processor executing the program instructions, the processor configured to receiving control signals from the remote control device, instructing the plurality of sensors, the plurality of output peripherals and deployment unit according to the received control signals, and sending a return signal with data processed by the processor from the plurality of sensors, the plurality of output peripherals and the deployment unit to the remote control device external from the saddle apparatus.

Another example aspect of the disclosed invention provides a saddle apparatus, including a first side sitting housing including a first plurality of illuminators, a first camera, and a first transducer for audio input or output and connected via a bus line, a second side sitting housing electrically coupled to the first side sitting housing via the bus line, including a second plurality of illuminators, a second camera, and a second transducer for audio input or output, and connected via the bus line, a computer readable storage medium storing program instructions, and a processor executing the program instructions, the processor configured to receiving control signals from a remote control device, instructing the first and second plurality of illuminators, the first and second cameras, and the first and second transducers according to the received control signals, sending a return signal with data processed by the processor from the first and second transducers, and the first and second cameras to the externally located remote control device.

Yet another example aspect of the disclosed invention provides a computer program product for encoding, the computer program product comprising a computer readable storage medium having program instructions embodied therewith, the program instructions readable and executable by a computer to cause the computer to send and receive control signals among a saddle apparatus, a remote control device, and a command control module, the saddle apparatus mountable on a user and communicating with the remote control device and the command control module, the saddle apparatus including a plurality of sensors for monitoring, a plurality of output peripherals, and a deployment unit for deployment of repeaters or munitions, instructing the plurality of sensors, the plurality of output peripherals and the deployment unit according to the received control signals from either the remote control device or the command control module, sending a return signal with data processed by the saddle apparatus from the plurality of sensors, the plurality of output peripherals and the deployment unit to the externally located remote control device and/or the command control module.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

It is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF DRAWINGS

The exemplary aspects of the invention will be better understood from the following detailed description of the exemplary embodiments of the invention with reference to the drawings.

FIG. 1 illustrates is a front view of the ISR platform system embodiment “saddle” in an example embodiment.

FIG. 2 illustrates a rear view of the system in an example embodiment of FIG. 1.

FIG. 3 illustrates is a right side front (starboard) perspective view of the system in an example embodiment of FIG. 1.

FIG. 4 a left side front (port) perspective view of the system embodiment in an example embodiment of FIG. 1.

FIG. 5 illustrates a side view of the system in an example embodiment of FIG. 1.

FIG. 6 illustrates a top view of the system in an example embodiment of FIG. 1.

FIG. 7 illustrates a front view of another configuration of the saddle unit in an example embodiment.

FIG. 8 illustrates a close-up view of the system being mounted on a canine in an example embodiment.

FIG. 9 illustrates a left side of the system being mounted on a canine in an example embodiment.

FIG. 10 illustrates a right side of the system being mounted on a canine in an example embodiment.

FIG. 11 illustrates a computer interface of system in an example embodiment.

FIG. 12 illustrates internal components of system in an example embodiment.

FIG. 13 illustrates a communication of system in an example embodiment.

FIG. 14 illustrates another configuration of the communication of system in an example embodiment.

FIG. 15 illustrates yet another configuration of the communication of system in an example embodiment.

FIG. 16 illustrates an exemplary hardware/information handling system for incorporating the exemplary embodiment of the invention therein.

FIG. 17 illustrates a signal-bearing storage medium for storing machine-readable instructions of a program that implements the method according to the exemplary embodiment of the invention.

FIG. 18 depicts a cloud computing node according to an embodiment of the present invention.

FIG. 19 depicts a cloud computing environment according to an embodiment of the present invention.

FIG. 20 depicts abstraction model layers according to an embodiment of the present invention.

### DETAILED DESCRIPTION OF A PREFERRED EMBODIMENTS

The invention will now be described with reference to the drawing figures, in which like reference numerals refer to like parts throughout. It is emphasized that, according to common practice, the various features of the drawing are not necessary to scale. On the contrary, the dimensions of the various features can be arbitrarily expanded or reduced for clarity. Exemplary embodiments are provided below for illustration purposes and do not limit the claims.

The disclosed invention allows integration of a plurality of video cameras, audio speakers and microphones, data sensors, microprocessors, firmware, software and essential wireless communications required to collect and compile information collected by integrated devices, convert it to data, and convey the data to users of the invention.

The saddle embodiment depicted in the example embodiment shows two (2) side mounted enclosures that contain the integrated components as detailed in the following. Integrated components include, for example, a plurality of video cameras, speakers, microphones, GPS (Global Positioning System) devices, illuminators, wireless communications devices, and expansion capabilities for specialized sensors or other devices. Specific components integrated into the embodiment vary depending on mission type. A custom microprocessor board is integrated to provide the onboard intelligence for the embodiment. The disclosed invention establishes a complete system that provides real-time situational awareness information (video, voice, location, sensor data and other data) to a remote user.

The disclosed invention is a water tight intelligent video, audio, data and communication embodiment for canines or other animals and also humans. The embodiment is made for integrated components and consists of a liner, an outer shell, and connecting strap that may or may not be adjustable. When assembled, the embodiment creates an air void for the insertion of said electrical components and also provides buoyancy.

The unit contains plurality of video cameras with the ability of night vision, two way radios for communication and related devices for audio, wireless communications, external illumination, water proof speaker and microphone, specialized sensors, and attachments for mounting and securing to a dog or animal.

The disclosed invention allows the user of the invention to connect to the saddle embodiment via wireless communications with a mobile or stationary computer and installed application software. This system (current invention) allows the animal handler to gain real time situational awareness of the animal's environment through real-time video, audio, and sensor data feeds. The disclosed invention also allows the animal handler to issue real-time verbal commands or initiate pre-recorded audio commands to the saddle embodiment's integrated speaker, thus controlling the animal off lead from a remote distance.

The disclosed invention also allows the dog or animal handler and/or other authorized user of the invention to control the animal off lead via real-time voice or pre-recorded audio commands conveyed to the saddle embodiment speaker.

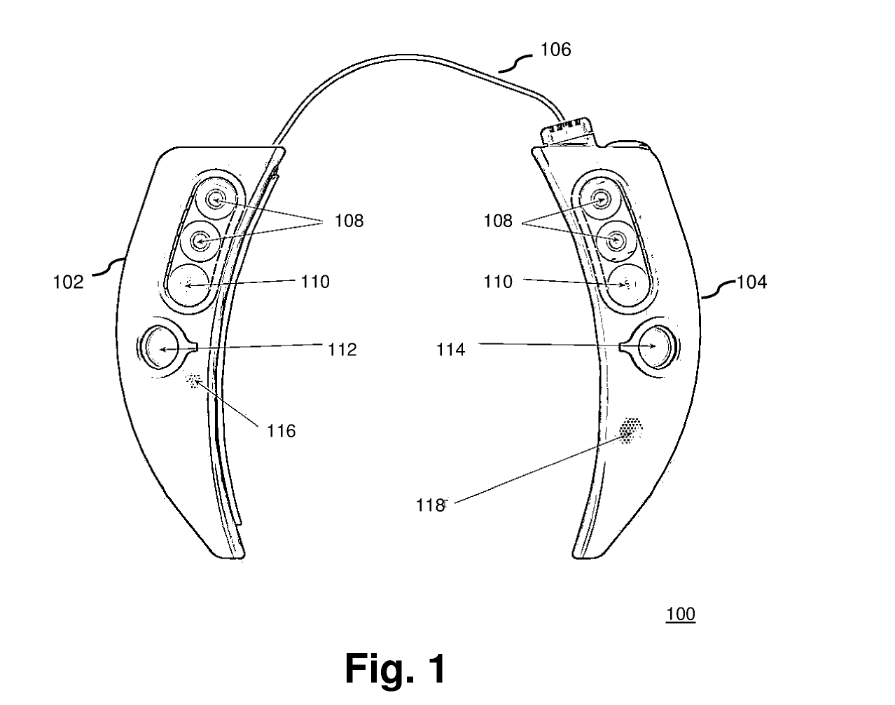

FIG. 1 illustrates is a front view of the ISR platform system embodiment “saddle” 100 in an example embodiment. There is a water-proof, video camera and communications embodiment herein known as the “Saddle” 100. The Saddle is comprised of two (2) side sitting enclosures connected by an adjustable strap with a right side sitting enclosure 102 and a left side sitting enclosure 104. The side sitting enclosures 102 and 104 are watertight and house all of embedded required electronics, as well as the battery. The battery and on/off switch is waterproof and is located on the back inside of the saddle side sitting component 102. The two (2) side sitting enclosures 102 and 104 are connected by a watertight wiring harness integrated into the connecting strap 106. Each side sitting enclosures 102 includes a plurality of illuminators that provide the cameras 112 and 114 increased vision under certain reduced light conditions. There are near infrared illuminators 108 and visible light illuminators that can each be independently controlled. There is a right side camera with lens showing 112 and a left side camera with lens showing 114. In addition, to provide additional feedback between the user and working canine wearing the saddle unit 100, there is a microphone 116 and a speaker 118 provided. The microphone 116 and speaker 118 are waterproof. The battery can be in in one side or both the right or left side sitting saddle 102 and 104. Additional sensors can be provided in the saddles 102 and 104 including temperature sensors, gas sensors, etc.

The cameras 112 and 114 are mounted with wide angle lens so that the handler can view the head or other body portions of the canine also in addition to the view ahead in order to give the handler and feedback of the dog itself. The cameras have the option to install wider angle or telephoto lenses per user requirements.

The enclosures 102 and 104 are formed from a lightweight and watertight housing configured to be attached to a canine or other animal. A liner and outer shell of the housing of the enclosures 102 and 104 are bonded together creating a sealed water tight enclosure. A printed circuit board located inside enclosures 102 and/or 104 includes or connects to a microprocessor, video encoders, Ethernet switches, GPS encoder and various communication software located therein.

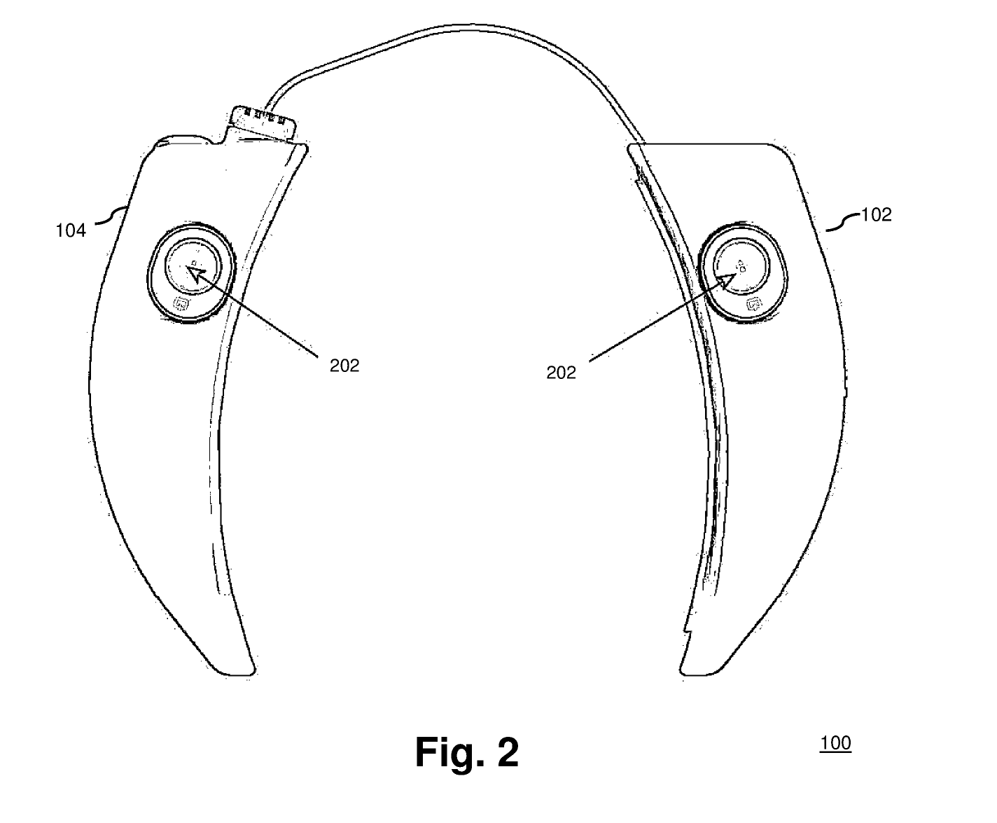

FIG. 2 illustrates a rear view of the system in an example embodiment of FIG. 1. Additional rear facing illuminators 202 can be added or other sensors that helpful to be in the rear facing portion. The rear facing illuminator can provide additional background light for the front facing cameras 112, 114 or other visual sensors mounted or provide a line of sight view for a remote user.

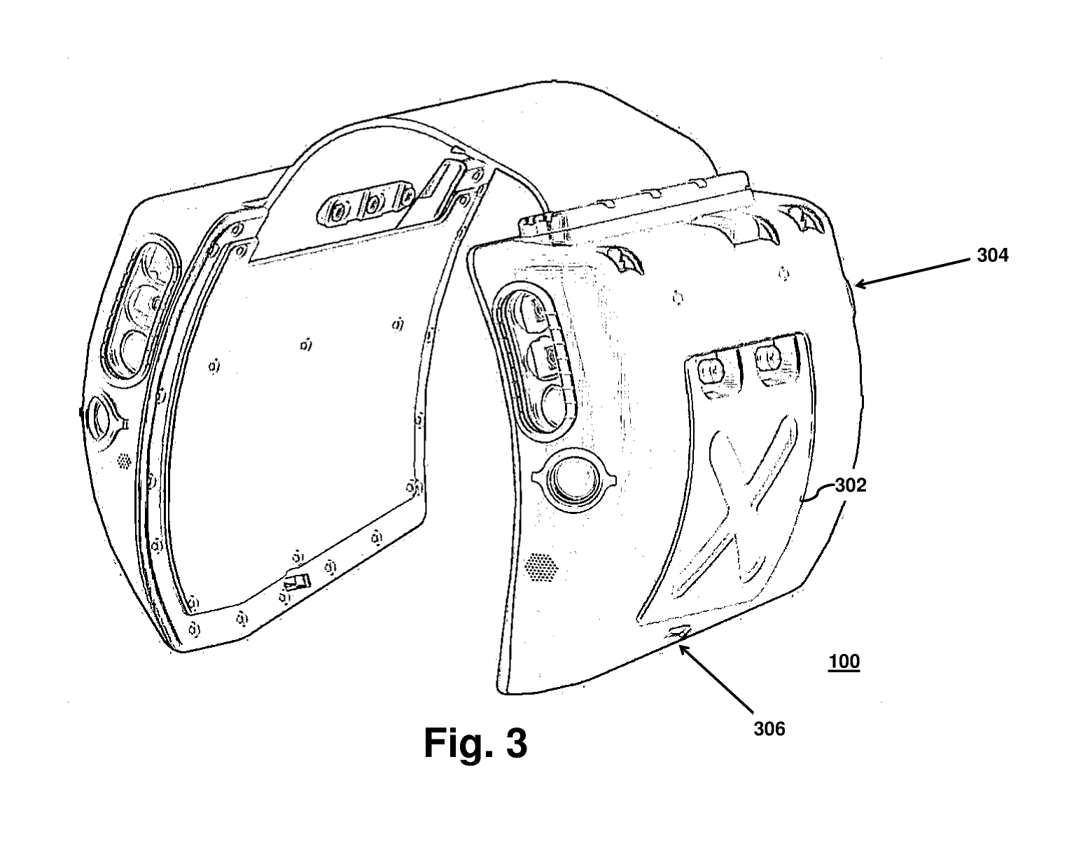

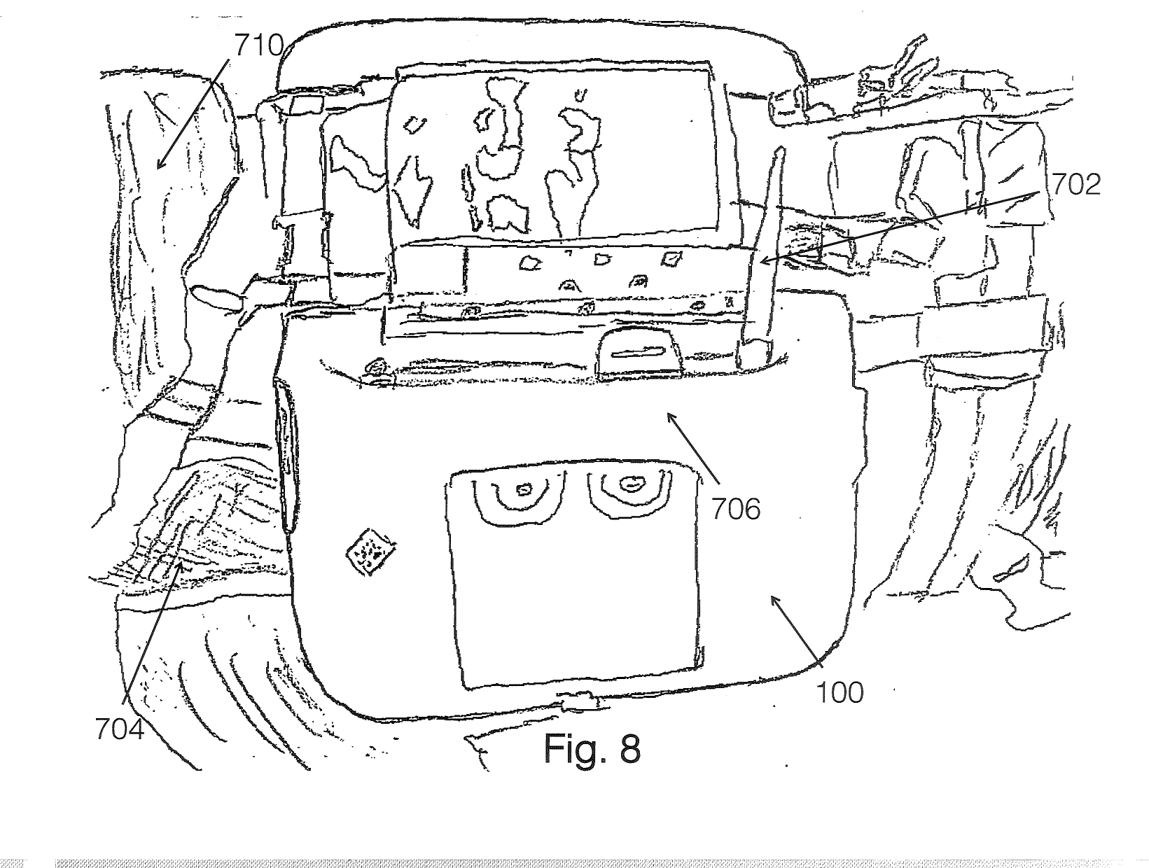

FIG. 3 illustrates is a right side front (starboard) perspective view of the system in an example embodiment of FIG. 1. A water tight access panel 302 is shown that allows access to the internal components such as the battery or other power source. The battery can be lithium ion battery or other power source such being aided by solar or other sources. The access panel 302 can also allow access to all other internal components. A similar access panel can be added to the other side sitting enclosure. The vest unit 704 (See FIG. 8) can also attach at point 306. The saddle unit 100 can also include deployment unit 304 (next to optional rear illuminators 202 or replacing the rear illuminators 202 with deployment unit 304) can deploy repeaters for communication, munitions, etc. The deployment unit 304 is controllable by remote. The deployment can be spring loaded, magnetic release, or other type of deployment device. The location of the deployment unit can be anywhere on the saddle unit 100. The dropping of the repeater radio increases the communications distance between the handler and saddle unit. The munition drop can be of lethal variety or non-lethal. Moreover, the munition can be exploded remotely via the remote control device or command control module or via a timer setting, or GPS location. For example, after the canine is a certain distance from certain munitions, it can be exploded. Certain type of canines for example are immune from certain type of munitions, for example tear gas, etc. Therefore, a canine unit would be more helpful in deploying a tear gas munition than a human. A surveillance kit (WiFi radio, camera, microphone, etc.) can be dropped. Dropping anything from the saddle unit 100 can be all controlled through the remote control device including from the laptop computer or a command center. Specialized sensors can also be dropped including biological, nuclear, chemical, other sensors that can communicate their information remotely, like for example using IP protocol.

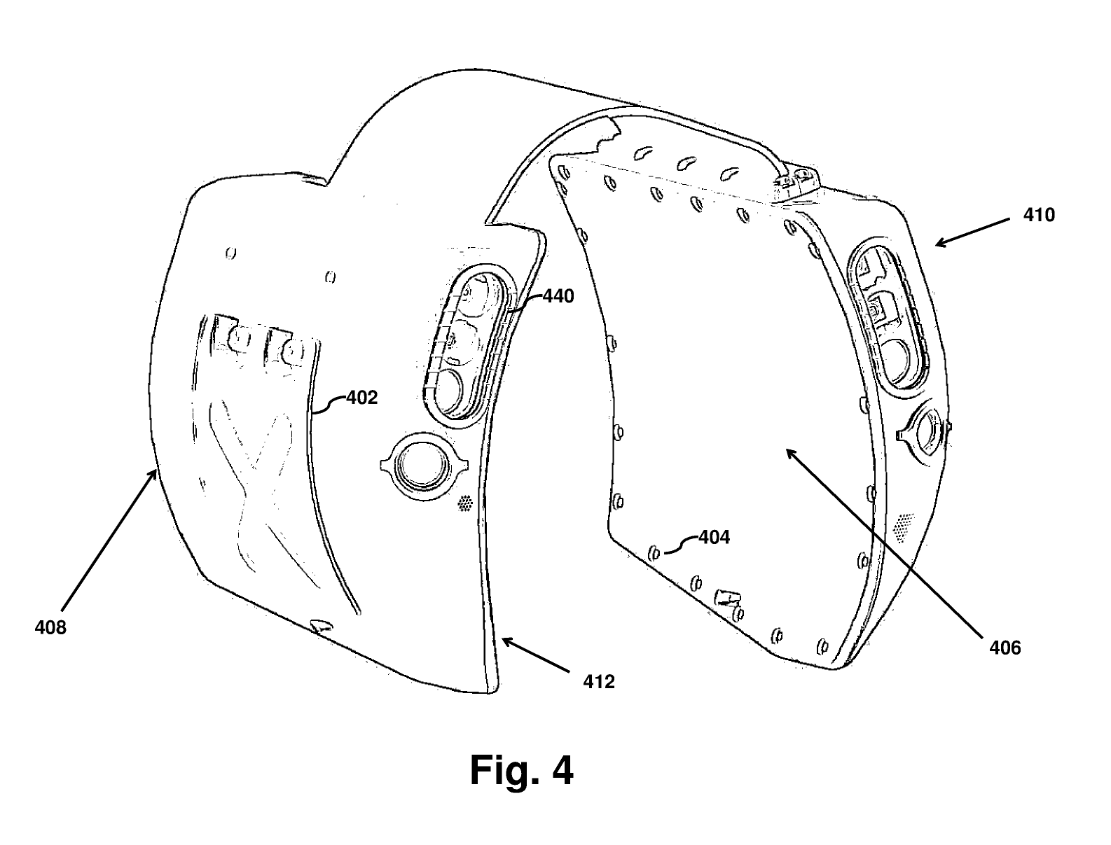

FIG. 4 a left side front (port) perspective view of the system embodiment in an example embodiment of FIG. 1. A water tight access panel 402 is provided on the saddle unit 100 for access to the internal components on the other side of the saddle unit. The fasteners 404 close the housing tightly for water proofing.

Silent Directional Control System 406 can be embedded in the shell of the saddle unit or sewn into the vest unit 704 and connected to the saddle unit via wired or wireless connection. The Silent directional control system 406 can include three or more hepatic vibrators that allow the handler at the remote control device (or control center module) to control the canine by pushing a button on the tablet in the remote control device. The onboard GPS system can allow auto directional control to get to a specific location.

A Mini UAV (unmanned aerial vehicle) canine platform can be mounted at, for example the rear point 408 of the saddle unit 100. The platform can hold a mini UAV that can broadcast aerial video back to the saddle unit 100 and can be multicast to multiple users. The UAV can be controlled by the canine handler via the remote control device or another user tied into the network via a meshed IP-RF (Internet protocol-radio frequency) radio or LTE (long term evolution). A mini remote controlled mini vehicle can also be mounted at 408.

A Weapons Platform can also be mounted anywhere on one of the sides 102 and/or 104 saddle unit 100, at for example, point 410. This will be a side mount system that will be able to control/movement up and down of a small pistol like system. This system can work with a Taser, stink spray or a small caliber pistol. The fire and movement control can be managed via the canine handler or another person attached into the meshed network at the remote control device or command center or any other location.

Muzzle Release platform can also be mounted to the saddle 100. The Muzzle release will connect to at a front portion 412 of the saddle 100, this muzzle system on command from the canine handler will release/drop the muzzle off of the dog.

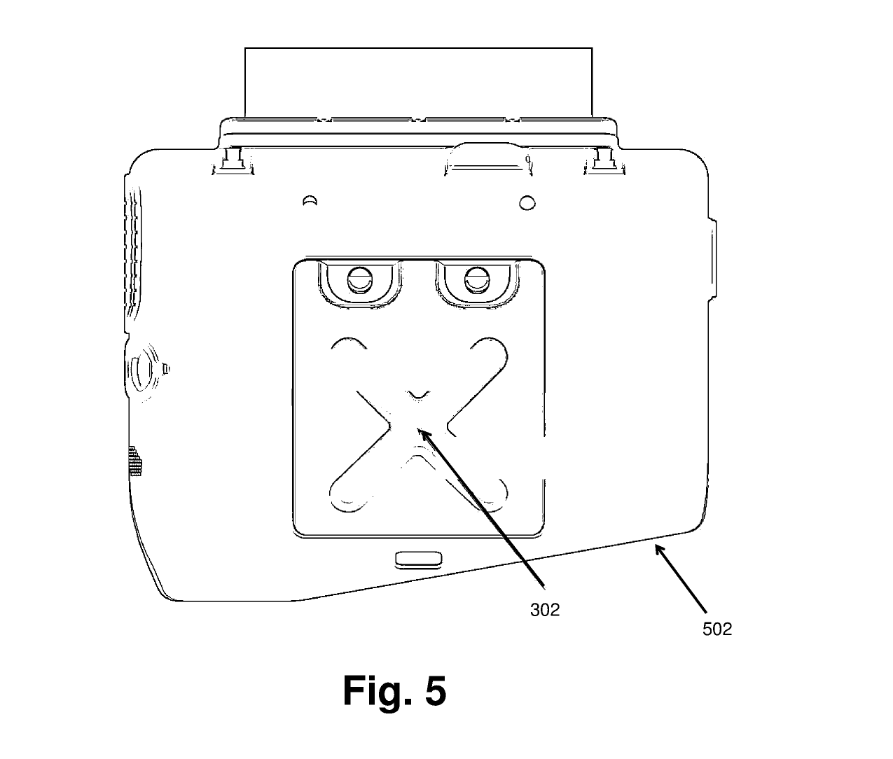

FIG. 5 illustrates a side view of the system in an example embodiment of FIG. 1. The housing is contoured for wearability by the canine as seen in the slanted portion 502 that has one side shorter than the other. The access panel 302 provides access to, for example, the removable battery and a power switch on one embodiment and the RJ45 maintenance port on the other side sitting embodiment at the access port 402.

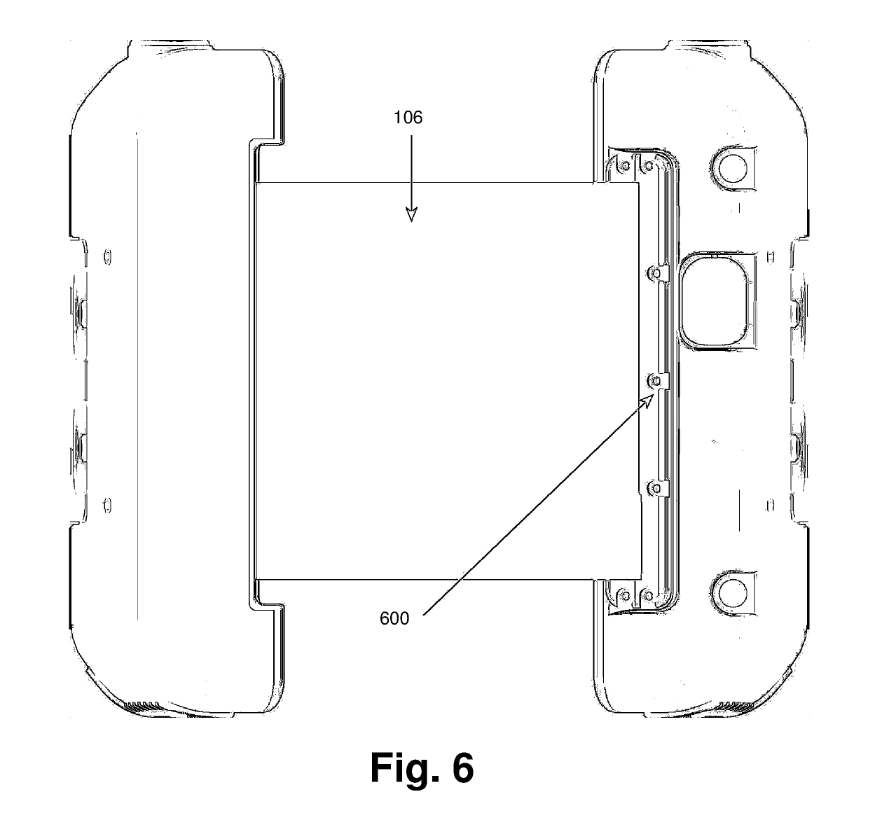

FIG. 6 illustrates a top view of the system in an example embodiment of FIG. 1. The adjustable strap 106 has a reinforced channel to route the electrical and communications wiring. The adjustable strap 106 is also adjustable in connected length to allow fitment to varying size canines or other animals. The strap 106 can also adjust for wear by a human. The adjustable mechanism provides a secure fixed length connection once fitment adjustments to the wearing animal are made and the connection is secured using the adjustment mechanism. The adjustable strap 106 also includes an adjustable strap lock mechanism 600 that helps to lock the strap in place.

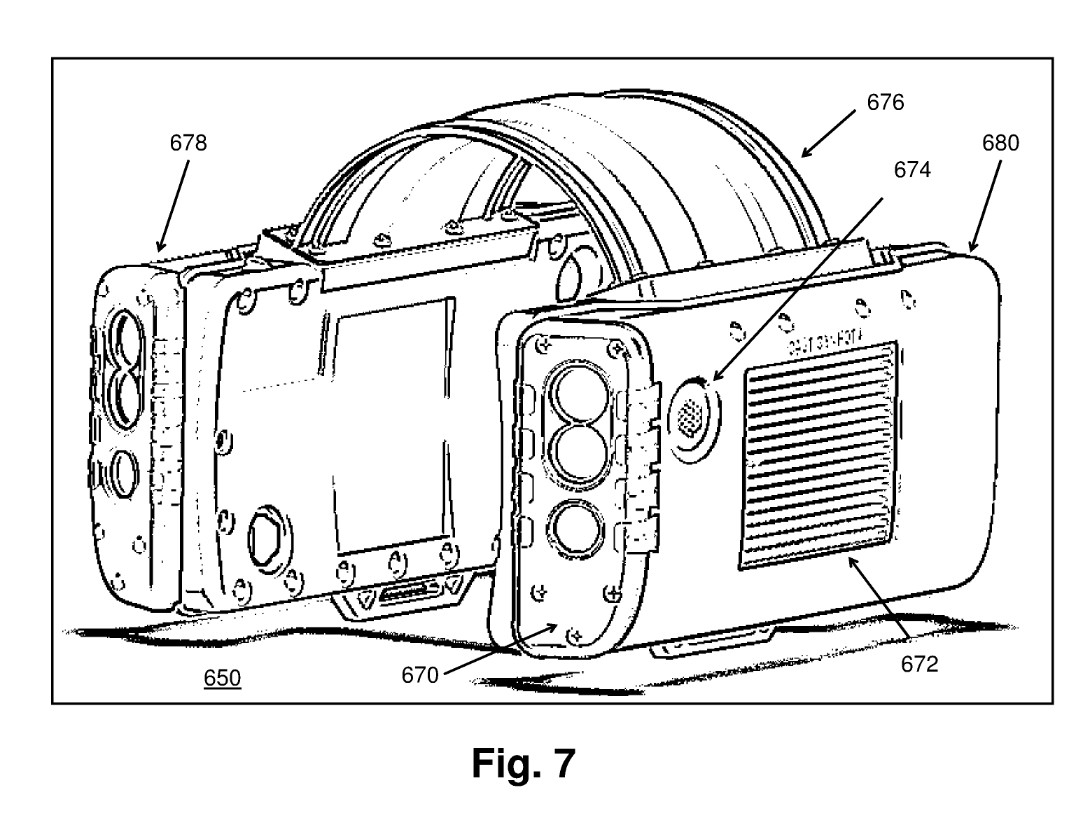

FIG. 7 illustrates a front view of another configuration of the saddle unit 650 in an example embodiment. In the alternative embodiment, all the components are similar to those in FIGS. 1 through 6 except as follows. In order to reduce the size of the saddle unit 650, the dimensions of left sitting enclosure 674 and right sitting enclosure 678 were reduced in order to make it easier for the canine to carry the load. There is a removable front bumper 670 added to provide added protection for the cameras and illumination units as seen in the saddle unit 100 of FIG. 1. The speaker/microphone unit 674 can be added to both the right and left side sitting enclosure 678 and 680. There is a ventilation grill 672 added to each side 678 and 680 to provide ventilation for the components inside. With the reduced size, the ventilation for the electronic components are helpful. Other locations for the vent grills can be made. The strap 676 can have the adjustability removed in order to reduce size. Both the saddle units 100 and 670 can include Kevlar or other similar bullet proof material added to the housing, strap and the vest unit. This provides for durability and added protection in field use.

FIG. 8 illustrates a close-up view of the system being worn by a canine 710 in an example embodiment. The saddle unit's 100 side sitting enclosures 102 and 104 are also comprised of one or more antenna 702 attached to the back cover or integrated internally. The antenna 702 are then connected to an internally integrated two way wireless radio for enhanced distant communication.

The saddle unit has a standardized quick attachment feature to secure it to an underlying saddle pad or vest unit 704 to protect the animals spine and fabric vest that is secured to the animal. The saddle unit is also comprised of an external bracket and external bracket attachment features 706 allowing the attachment of external devices. The vest unit 704 can also be a cooling Vest. The cooling vest can be electronically controlled via the canine as the temperature of the vest can go hot or cold based on the outside temperature or the temperature of the canine. The vest will be connected to the saddle unit and the RF chain.

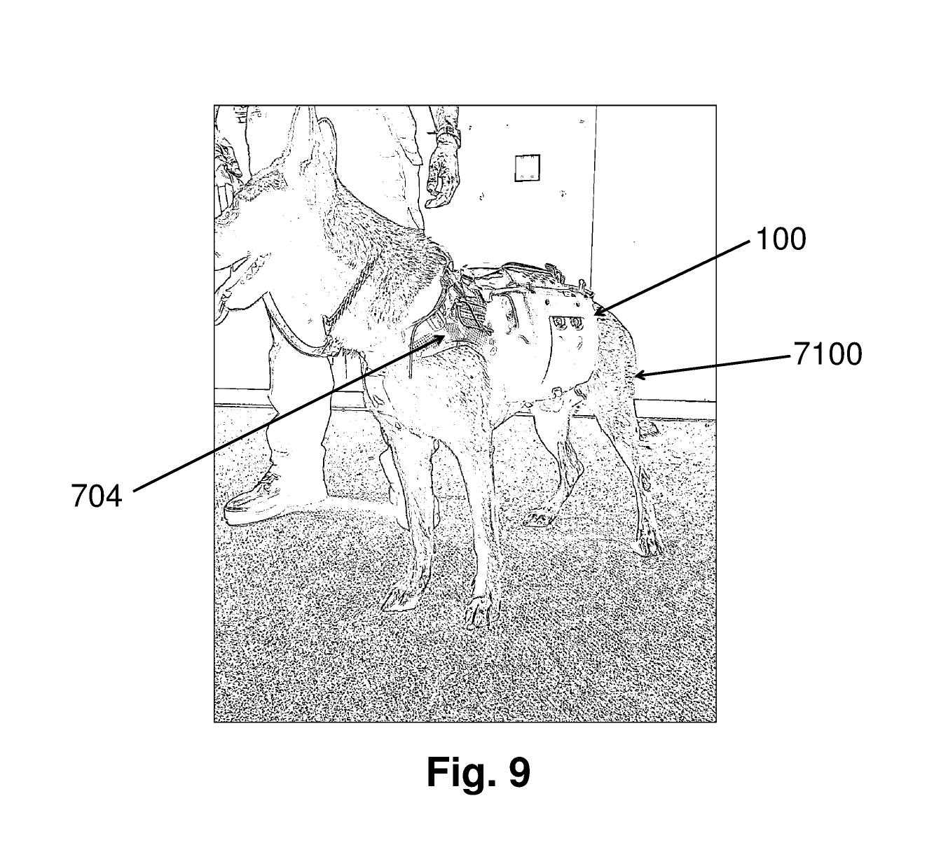

FIG. 9 illustrates a left side of the system being mounted on a canine in an example embodiment which shows the canine in the field.

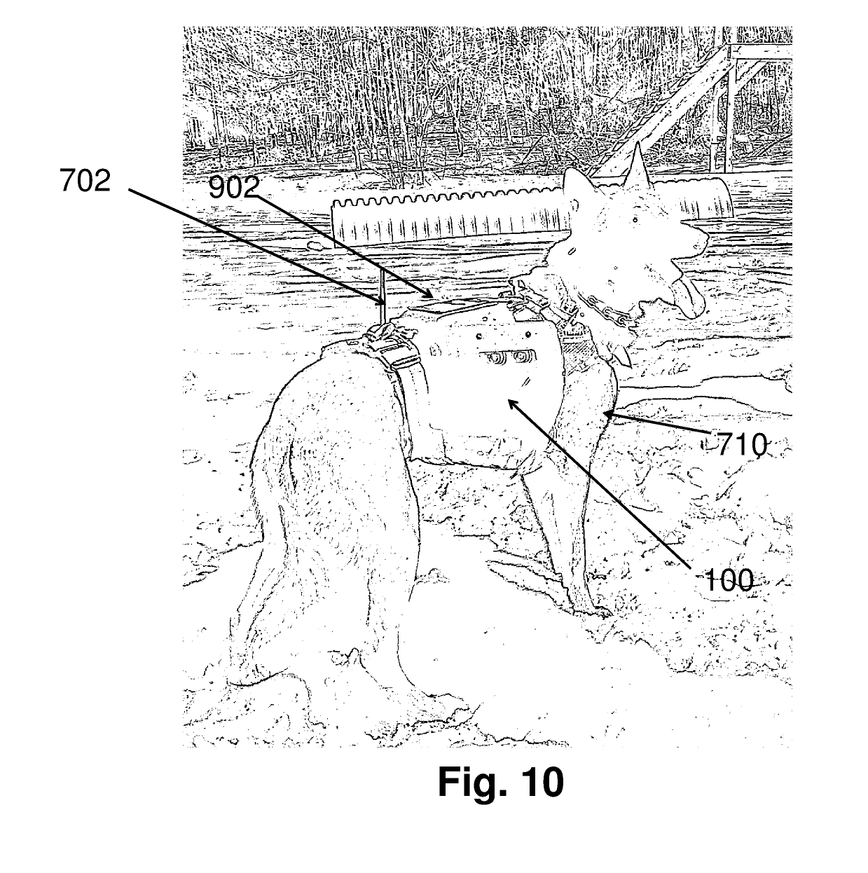

FIG. 10 illustrates a right side of the system being mounted on a canine in an example embodiment. The saddle unit 100 shows a portion of the standardized quick attachment feature 902 to secure it to an underlying saddle pad or vest unit 704 to protect the animals spine and fabric vest that is secured to the animal. The area of the unit on the top middle of the back of the canine is the “pontoon” that is a part of the quick release system 902, covering the strap 106 between the two side sitting enclosures 102 and 104 and protects the spine of the canine.

The remote control device 1200 and the command control module 1202 can process video analytics of the video received from the saddle unit 100. Object recognition can also be processed at the remote control device 1200 and the command control module 1202 via their onboard processors.

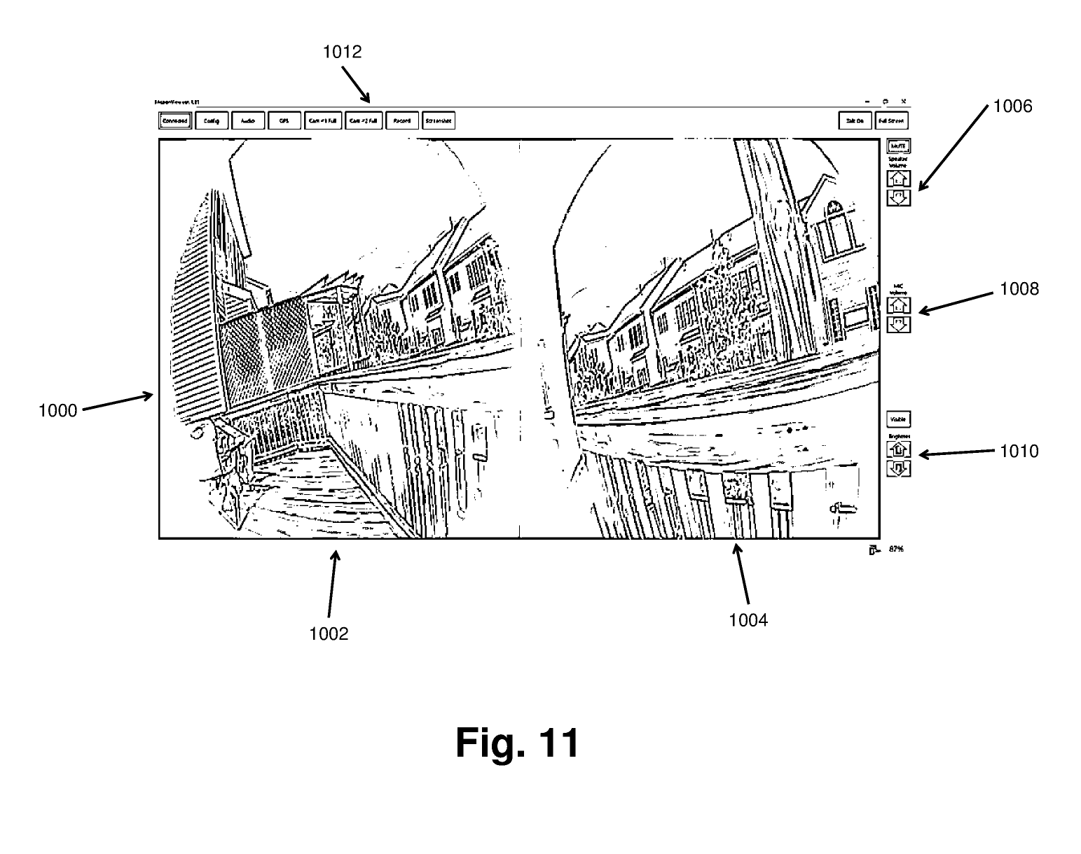

FIG. 11 illustrates a computer interface 1000 of system in an example embodiment. The computer interface 1000 that is used to control and receive communication from saddle unit 100 can be seen in a remote control module or even in the command control module. The interface 1000 can include a first view 1002 from the left mounted camera on the saddle unit 100, and the second view 1004 is also provided from the right side camera of the saddle unit 100. A selection can be made in the computer interface where one of the camera views is shown in the whole screen or other types of data is displayed. The user can control the saddle unit 100 via controls, such as 1012, 1006, 1008, and 1010. For example, selections of GPS, Audio and other items can be selected via controls 1012. The speaker volume can be controlled via a plurality of buttons 1006, the microphone volume can be adjusted via display arrowed buttons 1008, and brightness of the illuminators can be controlled 1010. Other items from the saddle unit 100 can be controlled via the computer interface. Moreover, such control features can be modified according to the customized use.

The system software provides an intuitive user interface to display video feeds, receive and convey audio, display GPS and all other data elements from the saddle unit, and control saddle components remotely. Missions can be recorded locally on the saddle unit 100 and/or remotely on the tablet computer.

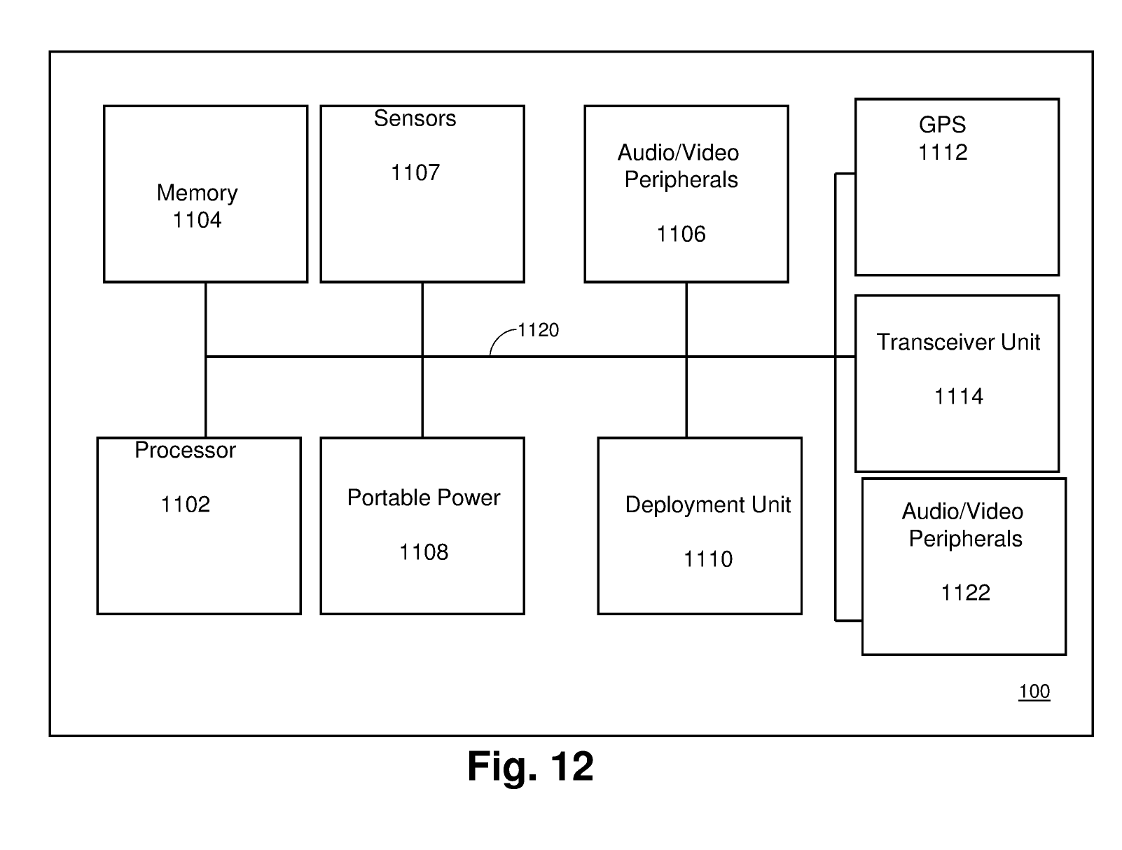

FIG. 12 illustrates internal components of system in an example embodiment. The saddle unit 100 can include a processor 1102 with a memory 1104 that includes a customizable program. The processor can control sensors 1107, audio/video peripherals 1106 and 1122, onboard GPS receiver 1112, and a deployment unit 1110. The processor 1102 can send and receive communication from the transceiver 1114 for wireless communication with the remote control device and/or the command control module. The plurality of components can be connected via bus 1120. The location of each or the units can be in either the left or right side sitting enclosures 102 and 104. The components can be integrated on a single or multiple boards.

Other than the sensors already mentioned, the sensors 1107 can also include biological, nuclear, chemical, or other specialized sensors.

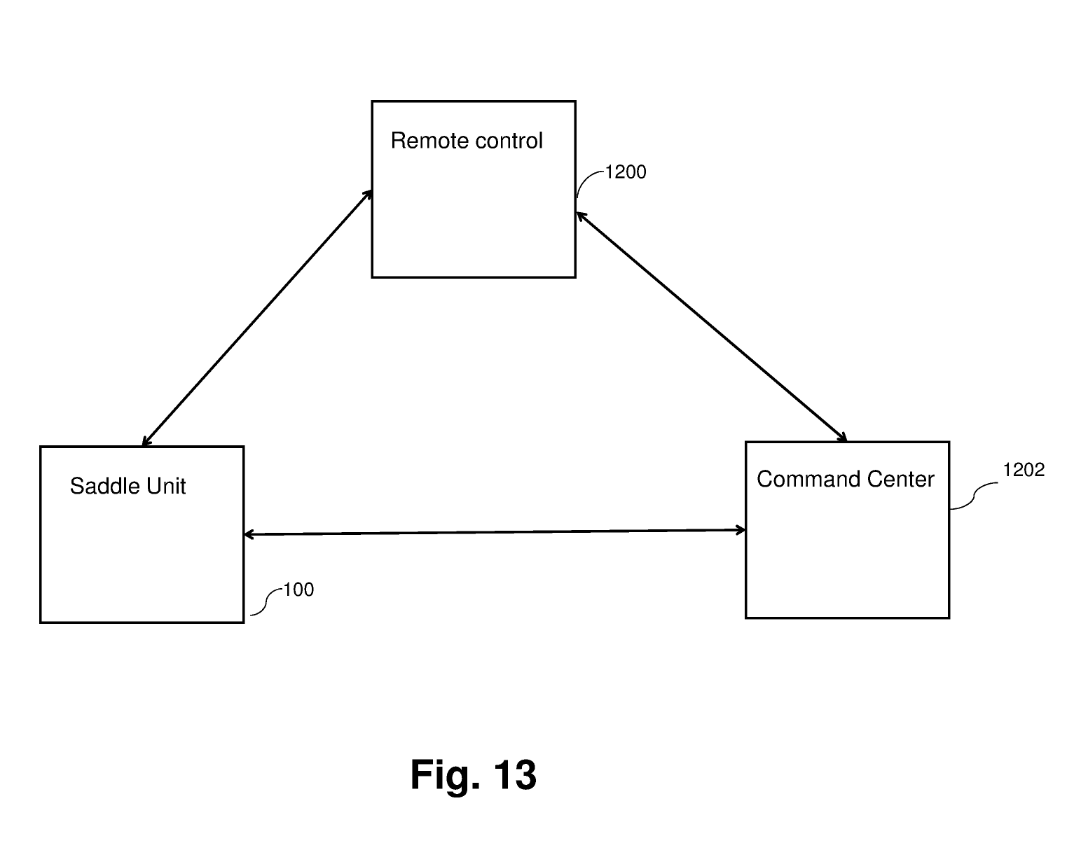

FIG. 13 illustrates a communication of system in an example embodiment. The Saddle unit can communicate and be controlled via the remote control device 1200. The remote control device 1200 can include a transceiver, processor and a display for controlling the saddle unit. The remote control unit device 1200 can communicate the data received from the saddle unit 100 back to a command control module 1202. This relay of information is helpful in controlling the bandwidth of communication and to avoid certain interferences that the saddle unit may incur when in the field such as in tunnels or buildings. In this manner, via the remote control unit 1200, the command center control module 1202 can receive the data from the saddle unit 100.

The command control module 1202 can include, for example, a system media server that records all data from the saddle unit 100 and allows others to view, review, and analyze.

The command control module 1202 can also communicate with the saddle unit 100 if the communication link is made. This adds an additional layer of redundancy in the communication line. The command center 1202 can also take over control of the saddle unit 100 should communications to the remote control 1200 be lost or compromised.

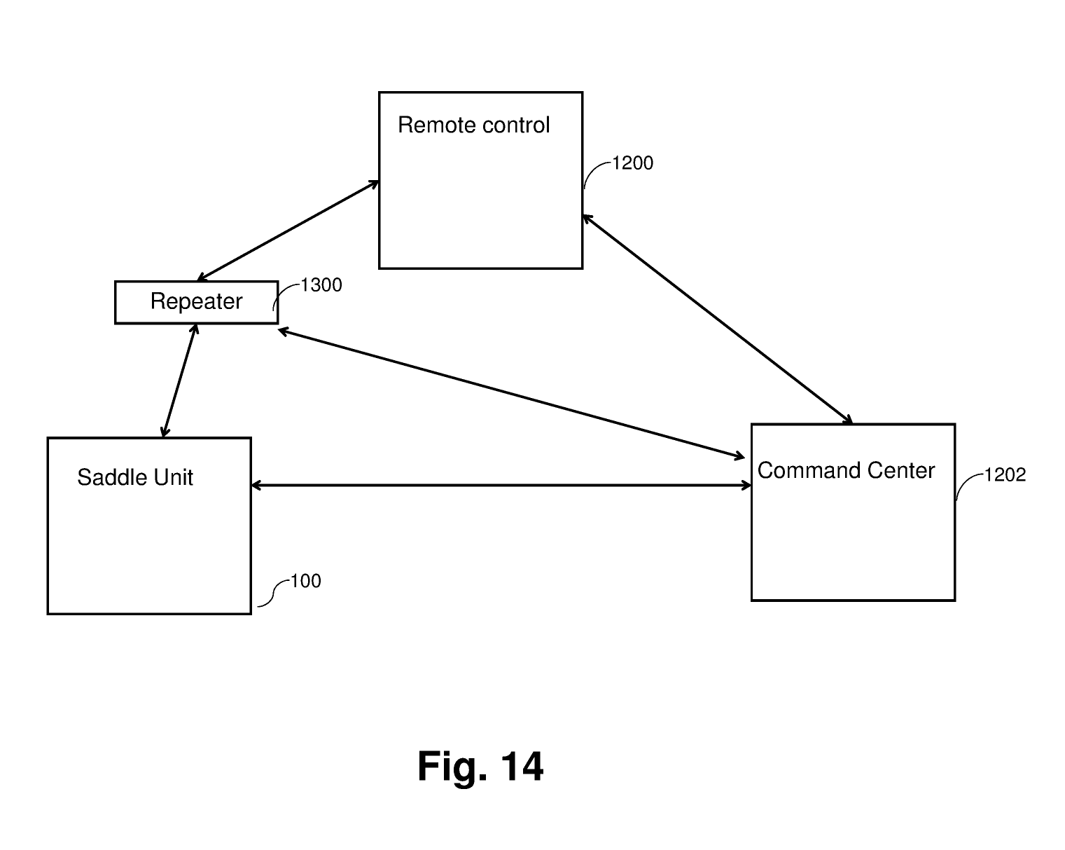

FIG. 14 illustrates another configuration of the communication of system in an example embodiment. A repeater 1300 that is deployed by the saddle unit can extend the communication path between the saddle unit 100 and the remote control device 1200. This relay of information is helpful in controlling the bandwidth of communication and to avoid certain interferences that the saddle unit may incur when in the field such as in tunnels or buildings. The repeater 1300 could also communicate with the command control 1202 to add an additional layer of redundancy.

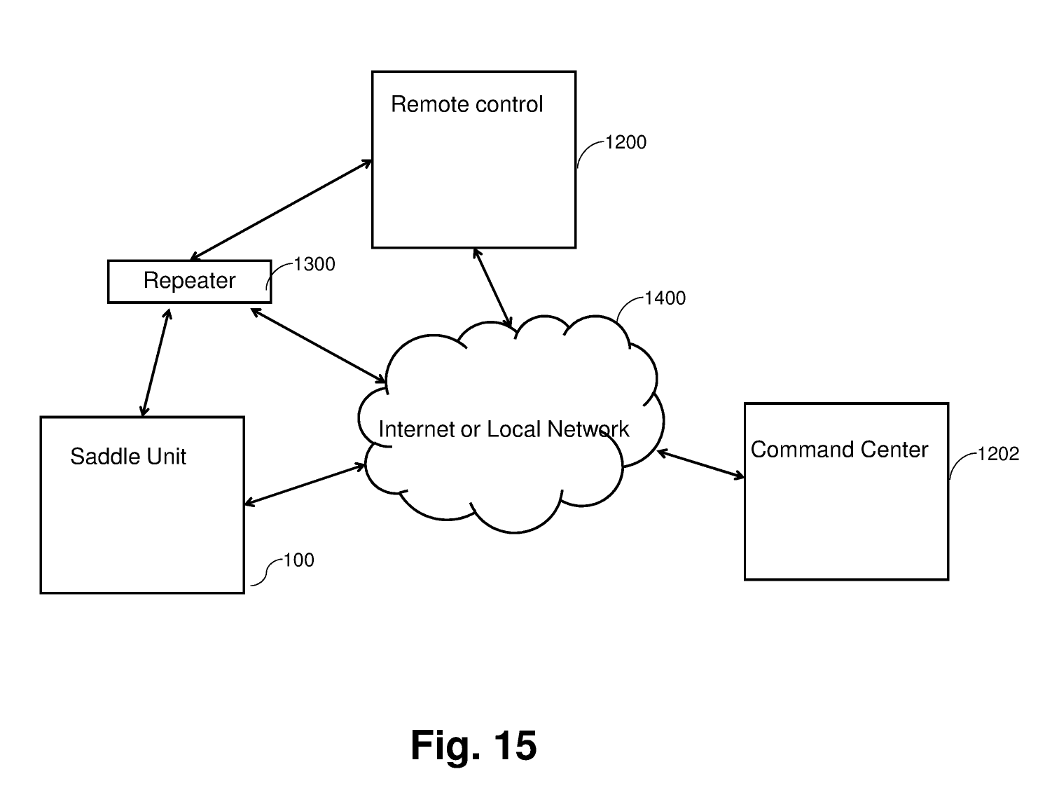

FIG. 15 illustrates yet another configuration of the communication of system in an example embodiment. The communication can also be routed through the Internet or a local network 1400 for any of the devices including the saddle unit 100, repeater 1300, remote control device 1200, and the command control unit 1202. For example, video taken by the saddle unit can be sent to the remote control device 1200 and command control module 1202 via the Internet 1400. This again extends the redundancy of the communication and the flexibility in controlling the saddle unit and communicating with the saddle unit.

All information (data) is transmitted between the handler and working dog at a remote and safe distance using, for example, integrated Internet Protocol (IP) radio types (i.e. 802.x or 4G LTE).

Visual information is displayed on a computer screen (tablet or other—5 inches or larger) and bi-directional audio information is relayed via headset connected to the computer at the remote control device 1200 or command center 1202.

The software used in the system establishes an intuitive user interface (UI) that displays the dual high definition Video streams, GPS map, sensor Data, and bi-directional Audio streamed to the Handler at 1200.

By leveraging radio mesh capabilities, multiple mobile 1200 or stationary command centers 1202 can also be included in the network to receive data through software for further or future analysis and application of human or video analytics.

Referring back to FIGS. 1 through 4, the saddle unit 100 allows the Handler (and others authorized to do so and running software for the system) to see what the canine sees; hear sounds in the dogs environment; monitor GPS and specialized sensors (if applicable); issue commands to control saddle components; record the mission; and control the canine via voice, or pre-recorded audio/tone command system. The canine can be controlled via the speakers 118 mounted.

The bi-directional audio system 116 and 118 also allows the Handler or other authorized entity using the software of the system and on the network to communicate to persons in the vicinity of the canine (injured personnel, perpetrators, etc) via the integrated microphone 116 and speaker 118 in the saddle unit 100.

The speaker 118 is also used to feedback the live voice of the handler for commands, pre-recorded tones, or pre-recorded voice commands of a handler. This is helpful when the original handler that the canine is trained by is not available at the remote control unit 1200.

Secure wireless communications options can include SILVUS TECHNOLOGIES Secure Wireless Mesh MN-MIMO, GENERAL DYNAMICS 4G LTE, GENERAL DYNAMICS FORTRESS™ Secure Mesh communications technologies, and many others.

The weight of the unit is extremely important and being approximately 5 pounds can be critical to ensure the effectiveness and mobility and endurance of the working canine.

Single Board Computer can be used in the saddle unit 100, due to the extreme impact protection and durability requirements encountered in the world of working canines, a purpose built single board computer with integrated Ethernet network has been built and integrated into the saddle unit 100. This single board computer provides the smaller fitment and impact resistance necessary for the environment.

The video can include Dual high definition (720 lines) low lux color video cameras are sensitive to both visible light and near infrared or better. Each camera has at least a 130 degree horizontal field of view and combined provide a 170+ degree field of view.

A 40 degree overlap of the dual cameras 112 and 114 field of view allows the canine handler to see the canine's head as this is a key requirement to establish an off lead remote command capability, as most of the canine Handlers interpretation of the situation is based on the canine's reactions and indicators.

The overlap also allows for forward viewing when in single camera zoom mode or GPS mode where the left side camera 112 feed is seen on the left side and the GPS map is on the right side.

The positioning of the cameras is the result of extensive study by the inventors and testing as it provides a combination of the optimal positioning on the canine for field of view and the least movement conveyed by the canine in motion.

The high definition video cameras 112 and 114 also have on board image stabilization (firmware) to reduce the image jitter during canine operations. A secondary capability is integrated into the software that reduces the frame rate to between 1 and 10 frames per second. This allows persons susceptible to motion sickness to switch to a “slide show” versus a motion picture eliminating or reducing the impact of the image motion.

The visible light 110 and near infrared illuminators 108 (at least one each on both sides of the saddle unit 100) are integrated into the saddle unit 100. Illuminator selection, power on/off, and intensity level are controllable in real time and remotely via software application of the system.

This uniquely allows the canine handler to select whether or not the canine is visible in the working environment. The visible light illuminators light up the whole area in front of the canine allowing everyone to see, though allows the working canine to be seen as well.

The near infrared illuminators 108 provide near infrared illumination to the handler and anyone else (command center or other field personnel running system software) via the system software application that executable on a computer. Any personnel wearing night vision goggles in the near infrared spectrum will also be able to take advantage of the near infrared illumination.

A high sensitivity microphone 116 is integrated into the saddle unit 100 and connected to the system to relay all environment sounds to the canine Handler at 1200 and/or mission control personnel at 1202.

A speaker 118 is integrated into a waterproof compartment in the saddle unit 100 to allow verbal commands to be conveyed from the canine Handler to the saddle unit 100 from a remote location at 1200. The bidirectional audio system may also be used to converse (or command) with people or perpetrators in the vicinity of the working dog and in different languages and voices.

The saddle unit has an onboard GPS receiver 1112 (See FIG. 12) and antenna 702 (See FIG. 8) connected to the transceiver unit 1114 (See FIG. 12) and conveys GPS location data to the canine Handler 1200 (and mission control center 1202) via the system software application.

Referring back to FIG. 12, there is a recording unit from the processor 1102 and the memory 1104 system has the ability to record all data collected by the saddle unit 100, as well as data sent to the saddle unit from the canine Handler 1200. There are at least two (2) recording systems within the system. One (1) is integrated into the saddle unit 100 whereby all data is recorded onto a USB (Universal Serial Bus) memory drive and the second (2nd) recording system is at the software application where all data is recorded at the tablet computer at remote control device 1200 or the mission control module 1202.

The recording at the tablet computer at the mobile remote control device 1200 (or mission control computer 1202) allows instant replay and analysis of events. The recording at the saddle unit 100 allows uninterrupted recording in the event the communications link is compromised or goes out. The USB drive or other flash memory can be retrieved and analyzed at the end of the mission. The remote control device 1200 can be mobile and the mission control module can be stationary.

A large protected saddle On/Off button allows the unit to be easily turned on when the Handler is either wearing gloves or manual dexterity is compromised due to the exposure to the cold or other extreme environment. The On/Off button can be located anywhere on the saddle unit 100.

The system software at the remote control unit 1200 works with the saddle unit operating system to allow for the radio to be turned off remotely. This is extremely important in scenarios where the radio frequency emissions may interfere with the mission or potentially trigger an explosive device detected by the canine. The canine Handler issues a recall command to the canine and then turns off the radio. The onboard recording will provide a record of the mission after the radio is powered down.

Referring back to FIG. 8, The antenna 702 can include Internal Dual MIMO (multiple input multiple output) Antennas. The saddle unit 100 integrates the a plurality of different radio technologies into the saddle unit 1100, including the use of MIMO technology. The design of the saddle unit 100 focuses on having all components contained within the saddle unit 100 to prevent any unnecessary snags or breaks when the units are in operation.

The integrated Ethernet network allows the saddle unit to be independent of the type of IP Radio needed, allowing different types of radio protocols to be integrated, and provides the option of integrating specialized sensors that interface via Ethernet.

The single board computer has an onboard operating system that processes all data (video, audio, GPS, control commands) and commands and packages the data to and received data from the IP Radio,

The saddle unit far exceeds canine capabilities by creating an advanced interactive information system that uniquely integrates dual high-definition video (color and near infrared (IR)), bi-directional audio (speaker and microphone), data, GPS, mission recording, illumination components, options for specialized sensors, as well as, off-lead verbal command capabilities into a lightweight computer controlled saddle 100.

The saddle unit 100 has been designed specifically to operate in the intense working dog environment and deflect frontal impacts. The saddle unit outer shell is made from impact resistant plastics with chemical and UV (Ultraviolet) resistance. A replaceable bumper system at the front portion or other portions of the saddle unit 100 provides additional impact resistance and scratch protection for the front of the saddle unit, camera lenses, illuminator lenses, and is made of impact absorbing material.

Pressure release valves are included on both saddle unit enclosures 102 and 104 when shipping at high altitude without pressurization. The battery selected also has a fuel gauge on it that conveys to system software, giving the canine Handler at 1200 knowledge of battery life.

As explained above, one of the features of the system is to establish a wireless system between a working dog and its Handler to allow the Handler to see and hear what is going on in the canine's environment and control the canine off-lead at a remote and safe distance by sending verbal commands remotely to the canine based on video and audio feed information from the saddle unit. Another feature is to provide situational awareness to others involved by transmitting all data to other authorized personnel (command center, mobile command center, other mission personnel) for real time analysis via human or computer analytics.

The system can be used in a wide variety of configurations, including (1) canine and Handler only (point to point), (2) canine and handler at remote control device 1200 and control Center (mobile or stationary) 1202 (point to multipoint), (3) Multiple canines and Handler teams with the command center analyzing all data feeds (multipoint to multipoint), and (4) roving canines (one to many) within a facility perimeter with all data streamed to central command, to name a few.

Exemplary Hardware and Cloud Implementation

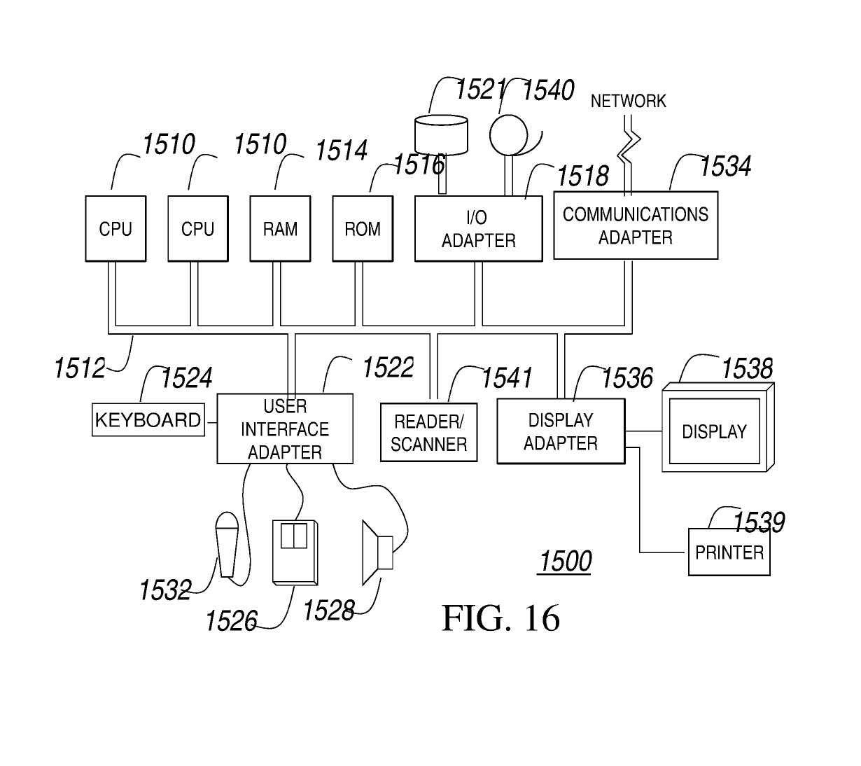

FIG. 16 illustrates another hardware configuration of an information handling/computer system 1500 in accordance with the disclosed invention and which preferably has at least one processor or central processing unit (CPU) 1510 that can implement the techniques of the invention in a form of a software program.

The CPUs 1510 are interconnected via a system bus 1512 to a random access memory (RAM) 1514, read-only memory (ROM) 1516, input/output (I/O) adapter 1518 (for connecting peripheral devices such as disk units 1521 and tape drives 1540 to the bus 1512), user interface adapter 1522 (for connecting a keyboard 1524, mouse 1526, speaker 1528, microphone 1532, and/or other user interface device to the bus 1512), a communication adapter 1534 for connecting an information handling system to a data processing network, the Internet, an Intranet, a personal area network (PAN), etc., and a display adapter 1536 for connecting the bus 1512 to a display device 1538 and/or printer 1539 (e.g., a digital printer or the like).

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, comprising signal-bearing storage media tangibly embodying a program of machine-readable instructions executable by a digital data processor incorporating the CPU 1510 and hardware above, to perform the method of the invention.

This signal-bearing storage media may include, for example, a RAM contained within the CPU 1510, as represented by the fast-access storage for example.

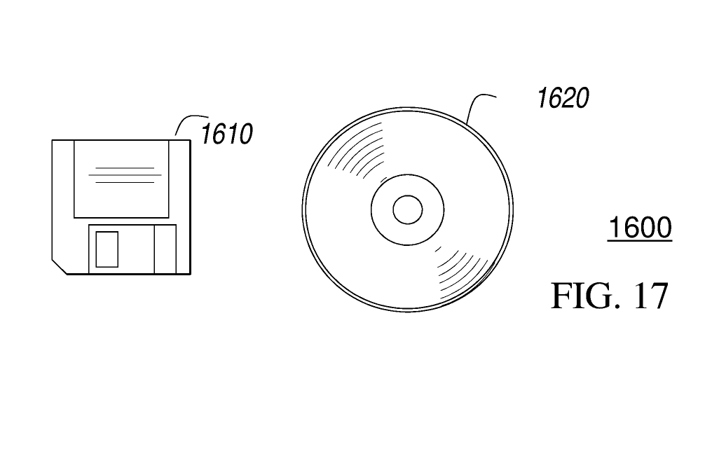

Alternatively, the instructions may be contained in another signal-bearing storage media 1500, such as a magnetic data storage diskette 1610 or optical storage diskette 1620 (FIG. 17), directly or indirectly accessible by the CPU 1510.

Whether contained in the diskette 1610, the optical disk 1620, the computer/CPU 1510, or elsewhere, the instructions may be stored on a variety of machine-readable data storage media.

Therefore, the present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

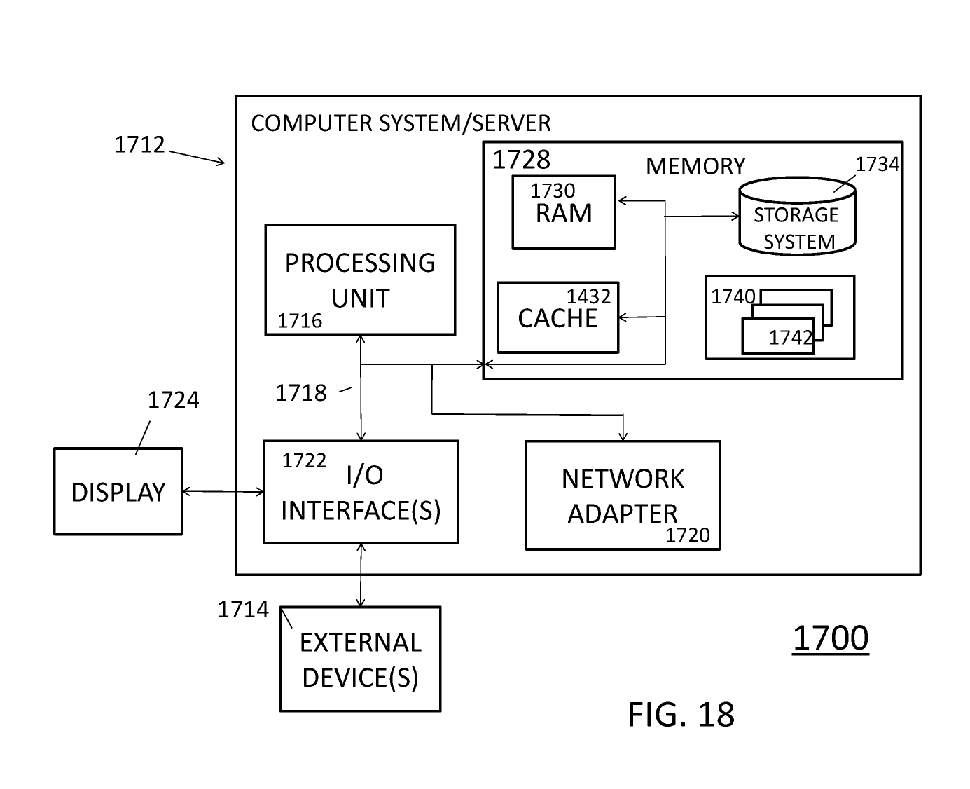

Referring now to FIG. 18, a schematic 1700 of an example of a cloud computing node is shown. Cloud computing node 1700 is only one example of a suitable cloud computing node and is not intended to suggest any limitation as to the scope of use or functionality of embodiments of the invention described herein. Regardless, cloud computing node 1700 is capable of being implemented and/or performing any of the functionality set forth hereinabove.

In cloud computing node 1700 there is a computer system/server 1712, which is operational with numerous other general purpose or special purpose computing system environments or configurations. Examples of well-known computing systems, environments, and/or configurations that may be suitable for use with computer system/server 1712 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 1712 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 1712 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 18, computer system/server 1712 in cloud computing node 1700 is shown in the form of a general-purpose computing device. The components of computer system/server 1712 may include, but are not limited to, one or more processors or processing units 1716, a system memory 1728, and a bus 1718 that couples various system components including system memory 1728 to processor 1716.

Bus 1718 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 1712 typically includes a variety of computer system readable media. Such media may be any available media that is accessible by computer system/server 1712, and it includes both volatile and non-volatile media, removable and non-removable media.

System memory 1728 can include computer system readable media in the form of volatile memory, such as random access memory (RAM) 1430 and/or cache memory 1732. Computer system/server 1712 may further include other removable/non-removable, volatile/non-volatile computer system storage media. By way of example only, storage system 1734 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1718 by one or more data media interfaces. As will be further depicted and described below, memory 1728 may include at least one program product having a set (e.g., at least one) of program modules that are configured to carry out the functions of embodiments of the invention.

Program/utility 1740, having a set (at least one) of program modules 1742, may be stored in memory 1728 by way of example, and not limitation, as well as an operating system, one or more application programs, other program modules, and program data. Each of the operating system, one or more application programs, other program modules, and program data or some combination thereof, may include an implementation of a networking environment. Program modules 1742 generally carry out the functions and/or methodologies of embodiments of the invention as described herein.

Computer system/server 1712 may also communicate with one or more external devices 1714 such as a keyboard, a pointing device, a display 1724, etc.; one or more devices that enable a user to interact with computer system/server 1712; and/or any devices (e.g., network card, modem, etc.) that enable computer system/server 1712 to communicate with one or more other computing devices. Such communication can occur via Input/Output (I/O) interfaces 1722. Still yet, computer system/server 1712 can communicate with one or more networks such as a local area network (LAN), a general wide area network (WAN), and/or a public network (e.g., the Internet) via network adapter 1720. As depicted, network adapter 1720 communicates with the other components of computer system/server 1712 via bus 1718. It should be understood that although not shown, other hardware and/or software components could be used in conjunction with computer system/server 1712. Examples, include, but are not limited to: microcode, device drivers, redundant processing units, external disk drive arrays, RAID systems, tape drives, and data archival storage systems, etc.

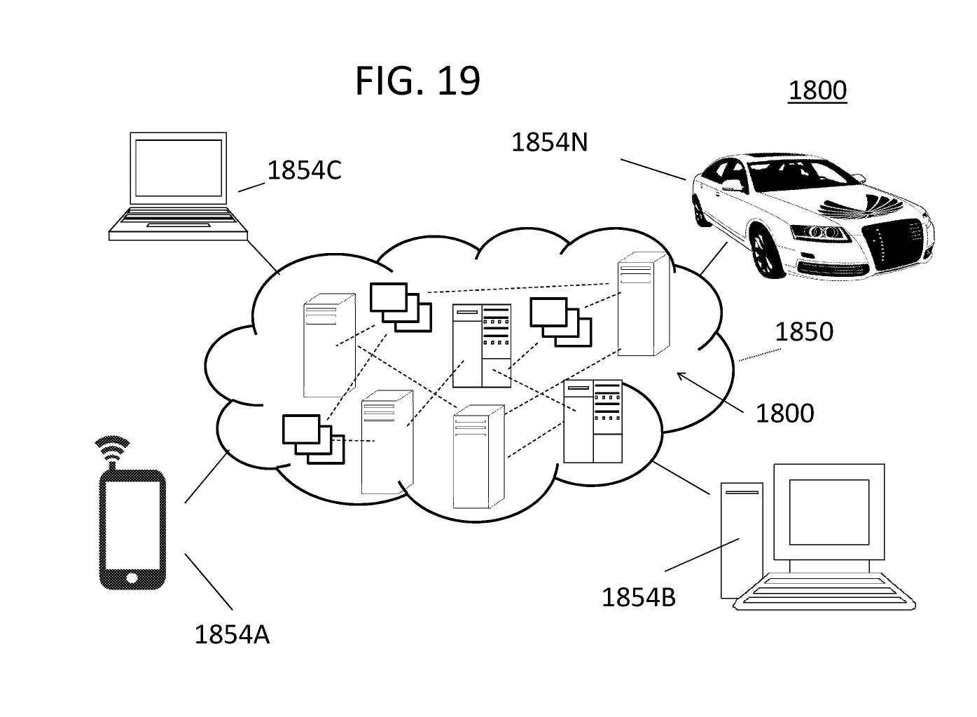

Referring now to FIG. 19, illustrative cloud computing environment 1850 is depicted. As shown, cloud computing environment 1850 comprises one or more cloud computing nodes 1800 with which local computing devices used by cloud consumers, such as, for example, personal digital assistant (PDA) or cellular telephone 1854A, desktop computer 1854B, laptop computer 1854C, and/or automobile computer system 1854N may communicate. Nodes 1800 may communicate with one another. They may be grouped (not shown) physically or virtually, in one or more networks, such as Private, Community, Public, or Hybrid clouds as described hereinabove, or a combination thereof. This allows cloud computing environment 1850 to offer infrastructure, platforms and/or software as services for which a cloud consumer does not need to maintain resources on a local computing device. It is understood that the types of computing devices 1854A-N shown in FIG. 19 are intended to be illustrative only and that computing nodes 1800 and cloud computing environment 1850 can communicate with any type of computerized device over any type of network and/or network addressable connection (e.g., using a web browser).

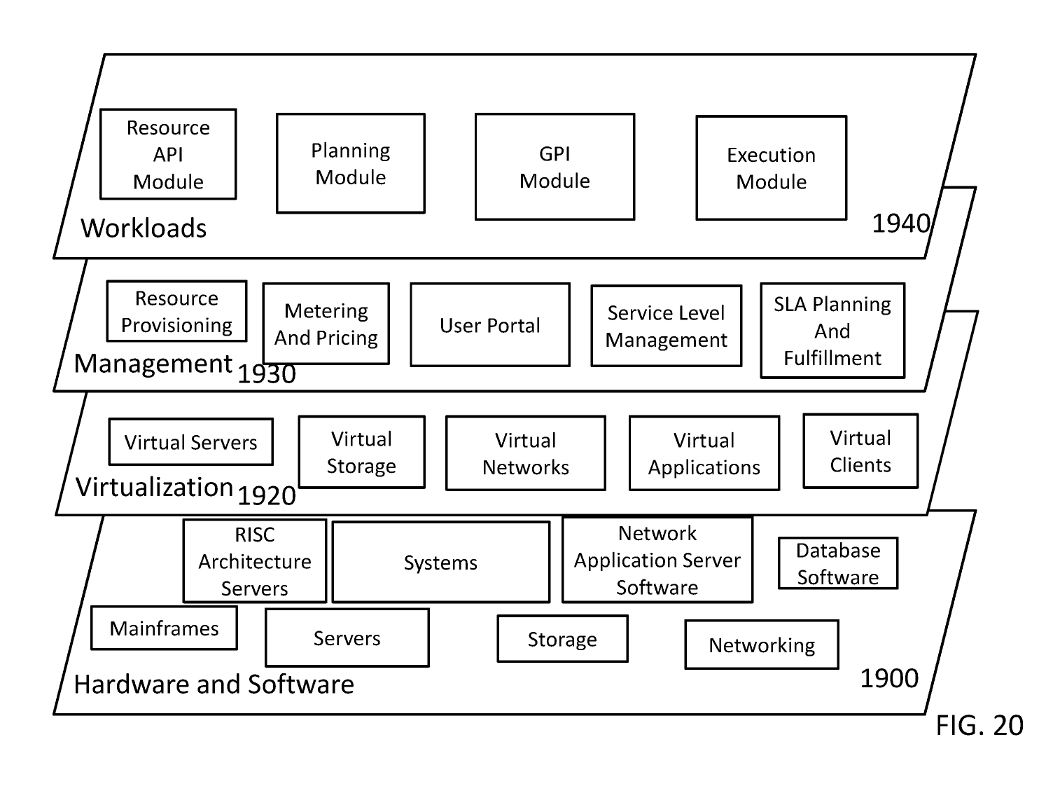

Referring now to FIG. 20, a set of functional abstraction layers provided by cloud computing environment 1850 (FIG. 19) is shown. It should be understood in advance that the components, layers, and functions shown in FIG. 20 are intended to be illustrative only and embodiments of the invention are not limited thereto. As depicted, the following layers and corresponding functions are provided:

Hardware and software layer 1900 includes hardware and software components. Virtualization layer 1920 provides an abstraction layer from which the following examples of virtual entities may be provided: virtual servers; virtual storage; virtual networks, including virtual private networks; virtual applications and operating systems; and virtual clients.

In one example, management layer 1930 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 1940 provides examples of functionality for which the cloud computing environment may be utilized. Examples of workloads and functions which may be provided from this layer include such functions as mapping and navigation; software development and lifecycle management; virtual classroom education delivery; data analytics processing; transaction processing; and, more particularly relative to the disclosed invention, the APIs and run-time system components of generating search autocomplete suggestions based on contextual input.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention. For example, the above saddle unit can be alternatively used and wearable on human users or other animals or even fully automated devices or drones.

What is claimed is:

1. A saddle apparatus comprising:
a processor;
a plurality of sensors controlled by the processor;
a plurality of output peripherals controlled by the processor;
a deployment unit controlled by the processor;
a transceiver controlled by the processor and communicating with a remote control device;
a computer readable storage medium storing program instructions; and
the processor executing the program instructions, the processor configured to:
receive control signals from the remote control device;
instruct the plurality of sensors, the plurality of output peripherals and deployment unit according to the received control signals; and
send a return signal with data processed by the processor from the plurality of sensors, the plurality of output peripherals and the deployment unit to the remote control device external from the saddle apparatus.

2. The saddle apparatus according to claim 1, wherein the plurality of sensors include a plurality of cameras for recording images.

3. The saddle apparatus according to claim 1, wherein the plurality of output peripherals include a plurality of visible light and rear infrared illuminators.

4. The saddle apparatus according to claim 1, wherein the deployment unit includes a deployment for repeaters or munitions.

5. The saddle apparatus according to claim 1, further comprising:
a removable portable power supply;
a waterproof housing, including a liner and outer shell bonded together creating a sealed water tight enclosure; and
a printed circuit board located inside the housing, the printed circuit board including, or connecting to, the microprocessor, video encoders, Ethernet switches, and a GPS encoder.

6. A system comprising the saddle apparatus according to claim 1, further comprising a vest unit configured to include padding and mountable to the saddle apparatus, and wearable by a user.

7. A system comprising the saddle apparatus according to claim 1, further comprising:
the remote control device including a second processor and a transceiver, configured to communicate and control the processor of the saddle apparatus.

8. The system according to claim 7, further comprising a command control module communicating with the remote control device, the command control module including peripherals to communicate with the remote control device or the saddle apparatus.

9. The system according to claim 8, wherein the remote control device, saddle apparatus, and command control module communicate with each other via an Internet Protocol.

10. The system according to claim 8, wherein the command control module comprises a media server to store data received from the saddle apparatus.

11. The system according to claim 8, further comprising the repeaters deployed by the deployment unit that communicate with the remote control device and/or the command control module in order to extend a line of communication.

12. A saddle apparatus, comprising:
a first side sitting housing comprising:
a first plurality of illuminators, a first camera, and a first transducer for audio input or output and connected via a bus line,
a second side sitting housing electrically coupled to the first side sitting housing via the bus line, comprising:
a second plurality of illuminators, a second camera, and a second transducer for audio input or output, and connected via the bus line;
a computer readable storage medium storing program instructions; and
a processor executing the program instructions, the processor configured to:
receive control signals from a remote control device;
instruct the first and second plurality of illuminators, the first and second cameras, and the first and second transducers according to the received control signals; and
send a return signal with data processed by the processor from the first and second transducers, and the first and second cameras to the externally located remote control device.

13. The saddle apparatus according to claim 12, further comprising a deployment unit that deploys repeaters or munitions for remote execution.

14. A system comprising the saddle apparatus according to claim 12, further comprising a vest unit configured to include padding and mountable to the saddle apparatus, and wearable by a user,
wherein the bus line extends over a spine of the user of the saddle apparatus and padded via the vest unit.

15. A system comprising the saddle apparatus according to claim 12, further comprising:
the remote control device including a second processor and a transceiver, configured to communicate and control the processor of the saddle apparatus.

16. The system according to claim 15, further comprising a command control module communicating with the remote control device, the command control module including peripherals to communicate with the remote control device and/or the saddle apparatus.

17. The system according to claim 16, wherein the remote control device, saddle apparatus, and command control module communicate with each other via an Internet Protocol.

18. The system according to claim 16, wherein the command control module comprises a media server to store data received from the saddle apparatus and communicates with the remote control device via the Internet.

19. A computer program product for encoding, the computer program product comprising a computer readable storage medium having program instructions embodied therewith, the program instructions readable and executable by a computer to cause the computer to:
send and receive control signals among a saddle apparatus, a remote control device, and a command control module, the saddle apparatus mountable on a user and communicating with the remote control device and the command control module, the saddle apparatus including a plurality of sensors for monitoring, a plurality of output peripherals, and a deployment unit for deployment of repeaters or munitions;
instruct the plurality of sensors, the plurality of output peripherals and the deployment unit according to the received control signals from either the remote control device or the command control module; and
send a return signal with data processed by the saddle apparatus from the plurality of sensors, the plurality of output peripherals and the deployment unit to the externally located remote control device and/or the command control module.

20. The computer program product according to claim 17, further comprising a user interface displayed on the remote control device for receiving the data from the saddle apparatus and controlling the saddle apparatus.
